(19) United States
(12) Patent Application Publication
(10) Pub. No.: US 2009/0281702 A1
(43) Pub. Date: Nov. 12, 2009

(54) RESOLVING STACK CLOSURE OF A POSITION CONTROLLED ELECTRIC BRAKE SYSTEM

(76) Inventor: Eric D. Cahill, Troy, OH (US)

Correspondence Address: SNELL & WILMER L.L.P. (GOODRICH), ONE ARIZONA CENTER, 400 E. VAN BUREN STREET, PHOENIX, AZ, 85004-2202, US

(21) Appl. No.: 12/401,918

(22) Filed: Mar. 11, 2009

Related U.S. Application Data
(60) Provisional application No. 61/051,490, filed on May 8, 2008.

(51) Int. Cl. G06F 17/00; F16D 66/02

(52) U.S. Cl. 701/78; 188/1.11 L

(57) ABSTRACT

A system, apparatus and method for resolving stack closure of a brake disk stack in a brake system is disclosed. In resolving the stack closure position, a force that can be applied by the reciprocating ram to the brake disk stack is limited, and then the reciprocating ram is commended to traverse into the brake disk stack. When the reciprocating ram contacts the brake disk stack and stops moving, the stopped position of the reciprocating ram is identified as the stack closure position.

### RELATED APPLICATION DATA

This application claims priority of U.S. Provisional Application No. 60/051,490 filed on May 8, 2008, which is incorporated herein by reference in its entirety.

### FIELD OF THE INVENTION

The present invention relates generally to brakes and, more particularly, to a method and apparatus for determining when an electro-mechanical brake actuator engages a multi-disk brake stack.

### BACKGROUND OF THE INVENTION

Known in the prior art are aircraft wheel and brake assemblies including a non-rotatable wheel support, a wheel mounted to the wheel support for rotation, and a brake disk stack having front and rear axial ends and alternating rotor and stator disks mounted with respect to the wheel support and wheel for relative axial movement. Each rotor disk is coupled to the wheel for rotation therewith and each stator disk is coupled to the wheel support against rotation. A back plate is located at the rear end of the disk pack and a brake head is located at the front end. The brake head houses a plurality of actuator rams that extend to compress the brake disk stack against the back plate. Torque is taken out by the stator disks through a static torque tube or the like.

In order to optimize braking response, it is desirable for each actuator ram to be positioned such that it just begins to engage the brake disk stack. Due to brake component wear, thermal expansion/contraction, maintenance operations, etc., however, the actuator rams may not always be positioned to engage the brake disk stack. As a result, when the brakes are applied the actuator rams may need to move a significant distance before the brake disk stack is engaged, which can affect braking response.

### SUMMARY OF THE INVENTION

A system, apparatus and method in accordance with the present invention enable the determination of a “just touching” position of a position controlled electro-mechanical actuator (EMA). As used herein, the “just touching” position refers to the location of the EMA's ram when the ram makes initial contact with a heat sink (e.g., a brake disk stack) of a multi-disk wheel brake, without (significantly) pushing into the stack. By determining the just touching location of the ram (also referred to as determining the stack closure position), one or more of the rams can be maintained at this location, thereby minimizing ram travel should the brakes be applied. Since ram travel is minimized, braking response is improved.

Further, the system, apparatus and method also can alter a “pinging” frequency of the EMAs after braking to compensate for thermal expansion and contraction (e.g., torque tube expansion and contraction). As used herein, the “pinging” frequency refers to the frequency at which the “just touching” determination is made. Also, the rate at which the ram accelerates and/or decelerates may be modified so as to minimize overshoot of the ram (e.g., minimize the likelihood that the ram pushes too far into the stack and creates a significant braking force) while at the same time enabling the “just touching” position to be determined in a minimal amount of time.

According to one aspect of the invention, there is provided a system that includes a brake disk stack, a reciprocating ram, and a motive device operatively connected to the reciprocating ram for selectively moving the reciprocating ram into and out of forceful engagement with the brake disk stack so as to apply and release a braking force on a rotatable wheel. The system further includes a controller for controlling the motive device for selective control of the reciprocating ram and regulation of the force applied by the reciprocating ram against the brake disk stack, and a position sensor which supplies a position signal representative of the position of the reciprocating ram. The controller is configured to effect displacement of the reciprocating ram and to determine a position at which the reciprocating ram makes initial contact with the brake disk stack.

According to another aspect of the invention, there is provided a brake controller and method for resolving stack closure of a brake disk stack in a brake system, the brake system including a motive device operatively connected to a reciprocating ram for selectively moving the reciprocating ram into and out of forceful engagement with the brake disk stack for applying and releasing braking force on a rotatable member, the brake controller operative to control the motive device for selective control of the reciprocating ram and regulation of the force applied by the reciprocating ram against the brake disk stack. The brake controller includes a processor and memory, and logic stored in memory and executable by the processor, wherein the logic includes i) logic that limits a force that can be applied by the motive device to the reciprocating ram and to the brake disk stack, ii) logic that commands the reciprocating ram to traverse into the brake disk stack, and iii) logic that when the reciprocating ram contacts the brake disk stack and stops moving, identifies the stopped position of the reciprocating ram as the stack closure position.

In a preferred embodiment, the controller can use the determined stack closure position as a reference position for at least one other reciprocating ram of the brake system. Further, the controller can be configured to repeatedly resolve the stack closure at a predetermined frequency. After a high speed braking event, for example, the controller can increase the frequency at which the determination is made. Also, the controller may resolve the stack closure only when a velocity of a vehicle carrying the brake system is less than a predetermined velocity.

In generating a position reference signal for the reciprocating ram, the controller can use an offset ramp (e.g., a linear ramp) to generate the position reference signal. A ramp enable location of the offset ramp can be based on a last determined stack closure position minus the product of the elapsed time since last determining the stack closure position and a maximum rate of displacement change of the ram.

Alternatively, the controller may ramp the position reference signal of the reciprocating ram at a rate that corresponds to the probability of the reciprocating ram being at the stack closure position. This can be accomplished, for example, by setting an initial ramp rate for the position reference signal, and then decreasing the ramp rate as the probability of the reciprocating ram making initial contact with the brake disk stack increases. Once the stack closure position has been resolved, the reciprocating ram can be maintained at the stack closure position during non-braking periods.

According to another aspect of the invention, there is provided a method for optimizing a braking response of a braking system, the braking system including an electro-mechanical actuator (EMA) and a heat sink, wherein the EMA is operative to apply a force to said heat sink so as to dissipate energy therein. The method includes: determining a location at which the EMA makes initial contact with the heat sink; and maintaining the EMA at the determined location during non-braking periods.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed.

### BRIEF DESCRIPTION OF THE DRAWINGS

The forgoing and other embodiments of the invention are hereinafter discussed with reference to the drawings.

FIG. 1 is a diagrammatic illustration of an exemplary multi-actuator computer controlled brake actuation system.

FIG. 2 is a diagrammatic illustration of a brake actuator and associated servo amplifier employed in the system of FIG. 1.

FIG. 3 is a perspective view of an exemplary brake housing and actuator assembly useful in the system of FIG. 1.

FIG. 4 is a schematic view showing a brake actuator assembly in relation to a new brake disk stack.

FIG. 5 is a schematic view showing the brake actuator in relation to a worn brake disk stack.

FIG. 6 is a flowchart illustrating a method for determining the just touching location of an EMA's ram.

FIG. 7 is a graph illustrating a first ramp function that may be implemented in the method of FIG. 6.

FIG. 8 is a graph illustrating a second ramp function that may be implemented in the method of FIG. 6.

### DETAILED DESCRIPTION

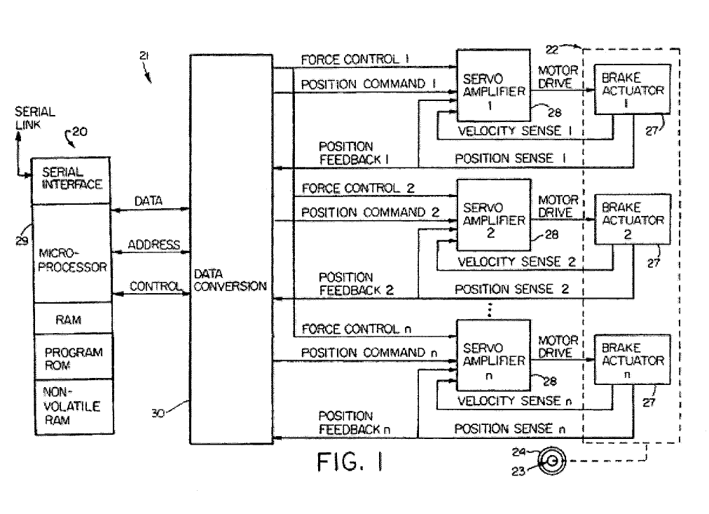

Referring now in detail to the drawings, FIG. 1 diagrammatically illustrates an exemplary multi-actuator computer controlled brake actuation system 20 to which the principles of the invention may be applied. The major functions of the system 20 are performed by a controller 21 and a brake actuator assembly 22. The brake actuator assembly 22 may be mounted in a conventional manner on a wheel and brake assembly 23 to apply and release braking force on a rotatable wheel 24 of such wheel and brake assembly. The present invention is particularly suited for use in aircraft braking systems, as will be appreciated by those skilled in the art.

Because the invention was conceived and developed for use in an aircraft braking system and particularly in association with the system 20, it will be herein described chiefly in this context. However, the principles of the invention in their broader aspects can be adapted to other types of systems. Moreover, the following discussion of an exemplary multi-actuator computer controlled brake actuation system is given for the sake of illustration and not by way of limitation, except as defined in the claims included at the end of this specification. Accordingly, only general operational details and features of such system will be described so as not to obscure the teachings of the present invention with details that may vary from one particular application to another.

In the illustrated exemplary system 20, the brake actuator assembly 22 includes at least one and preferably a plurality of electro-mechanical actuators (EMAs) 27. The controller 21 includes a corresponding number of independent servo amplifiers 28, a micro-processor 29 with associated peripherals, and a data input/output (I/O) circuitry 30. As depicted, plural (for example, four) independent, linear electro-mechanical servo loops operate in a position mode, i.e., the linear position of each actuator is a function of an analog input voltage (or digital equivalent for a digital signal processor) applied to a position command input.

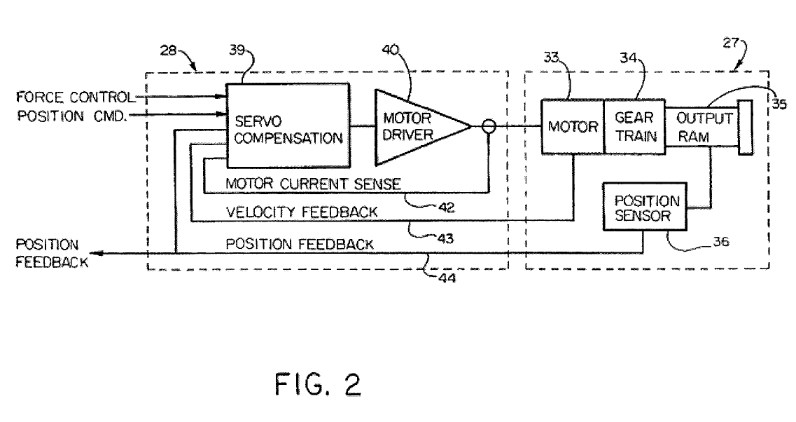

In FIG. 2, a representative electro-mechanical brake actuator 27 and associated servo amplifier 28 are illustrated in greater detail. The brake actuator 27 includes an electric servo motor 33, gear train 34, and a reciprocating output ram 35. The brake actuator has associated therewith an output ram position sensor 36 which provides for actuator position feedback as depicted. Although not shown, the brake actuator 27 also has associated therewith a motor tachometer to provide for velocity feedback.

The servo amplifier 28 includes servo loop compensation networks and amplifiers 39, and a DC motor driver 40 with associated control logic and current control circuitry. More particularly, the position servo amplifier 28 may include an inner motor current control servo loop 42, an intermediate motor velocity servo loop 43, and a ram position servo loop 44. Each loop may be compensated to obtain desired performance in terms of bandwidth, and to provide for uniform dynamic response of all brake actuators 27. In addition, the servo amplifier 28 includes means for controlling motor current and therefore the output force of the brake actuator in response to a force control input. The force control input may be an analog input signal that controls motor current level while the aforesaid position command input controls actuator displacement. As will be appreciated, the analog input signals may be replaced by digital input signals if a digital signal processor is used in the servo amplifier for actuator control.

As indicated, the displacement of each actuator 27 is controlled by the electronic controller 21 (FIG. 1). The micro-processor 29 of the controller provides brake control algorithm processing, temporary data storage, in RAM, program memory storage, non-volatile data storage, and control of the servo amplifiers 28 via the input/output circuitry 30. The input/output circuitry 30 provides for digital-to-analog data conversion, generating the analog position commands and the analog motor current control commands to the four actuators, analog-to-digital data conversion to monitor the actuator position sense and motor current feedback signals, and signal discretes for auxiliary functions such as motor brake control. The micro-processor may also be interfaced via a serial communication link with other control components as needed, such as, for example, an anti-skid brake control unit. Although a micro-processor is utilized in the illustrated preferred embodiment, processing alternatively could be done analog as opposed to digital, or intermixed with digital processing as may be desired.

In the illustrated system, the four servo amplifiers 28 (FIG. 2) are independent and functionally identical, each amplifier being controlled by the micro-processor 29, responding to the position commands and motor current control signals from the processor, and feeding back the actuator position and motor current sense signals to the processor via the I/O circuitry 30.

The controller may use two separate power sources: for example, a 28 VDC supply to power the low level electronic circuitry and 28 to 270 VDC supply to power the four actuator motors through the motor driver power stage. The 28 VDC actuator power may be utilized in emergency situations when 270 VDC is not available due to power system fault.

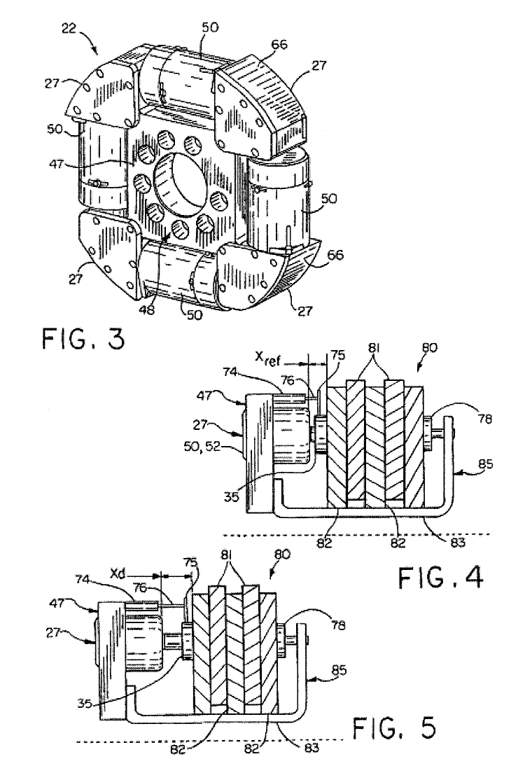

Further details of an exemplary brake actuator assembly 22 are shown in FIGS. 3-5. The brake actuator assembly includes a housing 47 that provides for the mounting of an electro-mechanical actuator 27, it being understood that typically multiple actuators will be mounted to the housing, such as four functionally identical actuators located at respective quadrants of the housing. The illustrated housing has a bolt circle 48 for mounting to the overall wheel and brake assembly 23 (FIG. 1). Each actuator 27 may include a DC brushless servo motor 50 and suitable reduction gearing 52 that translates rotary motor motion to linear motion of the ram 35 (the rams are hidden from view in FIG. 3). The brushless DC servo motor 50 may have integrated or otherwise associated therewith a friction type, fail-safe (power-off engaged) brake (not separately shown), and a resolver (not separately shown) for motor rotor commutation and angular velocity sensing. The resolver provides motor position feedback and velocity information. In particular, the resolver provides an electrical signal that is proportional to motor shaft position.

The ram 35 of each actuator is mechanically connected to an LVDT position sensor 74, such as by bracket 75. The LVDT armature 76 may be adjustably attached to the bracket (or the sensor body to the brake housing) by suitable means that provides for LVDT setting and position calibration. A cover (not shown), or the like, may be provided to protect for the LVDT mounting mechanism. Although an LVDT sensor is preferred, other types of position sensors/transducers may be used as desired for a particular application.

The purpose of the brake actuator(s) 27 is to impress a clamping force on the stack 80 of brake disk elements. The electro-mechanical (EM) actuator(s) operate simultaneously to produce a clamping force between a brake reaction plate 78 and the actuator output rams 35. An exemplary system utilizes four actuators, operating simultaneously, to provide the total brake clamping force required. However, the size and number of actuators may be varied to provide the total brake clamping force required. The actuators may be operated in a controlled displacement mode such that the clamping force is proportional to the deflection of the reaction plate. Although each actuator can operate independently, the actuators may be commanded in pairs (or otherwise), the actuators of each pair being located physically on diametrically opposite sides on the brake housing.

The brake disk stack 80 includes alternating rotor disks 81 and stator disks 82 mounted with respect to a torque tube 83 or similar member and the wheel (not shown) for relative axial movement. Each rotor disk 81 is coupled to the wheel for rotation therewith and each stator disk 82 is coupled to the torque tube 83 against rotation. A back plate 85 is located at the rear end of the brake disk stack and functions as a force reaction member via the reaction plate 78. The brake actuator 27 is mounted to brake housing 47 fixed with respect to the torque tube. The ram 35 of the actuator extends to compress the brake disk stack 80 against the back plate 85, and torque is taken out by the stator disks 82 through the static torque tube 83 (or the like).

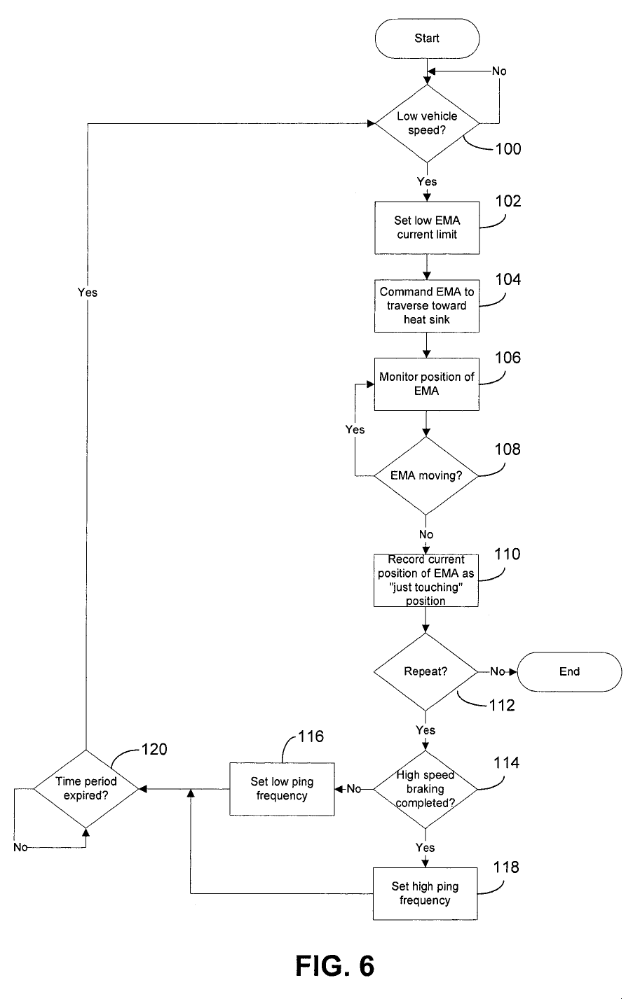

In accordance with the invention, the controller 21 (FIG. 1) is suitably programmed to carry out a stack closure routine which is illustrated by the flow chart shown in FIG. 6. The stack closure routine determines a “just touching” position of the EMA's ram 35 and heat sink (e.g., the brake disk stack 80).

Beginning at block 100 of FIG. 6, a determination is made whether or not to enable or disable the stack closure routine. This determination, for example, can be based on whether or not the vehicle is moving at a low or high rate of speed (e.g., the routine is enabled at low speeds, and disabled at high speeds). As will be appreciated, the specific criteria for determining low or high rates of speed can be dependent on specific application (e.g., on the type of vehicle). For example, in the context of an aircraft a low rate of speed may be speeds typically encountered during taxing on a runway (or any “non-take-off” speeds), while in the context of an automobile a low rate of speed may be speeds below five miles per hour. If at block 100 the vehicle is not traveling at a low speed (i.e., the vehicle is traveling at a high speed), the method loops at block 100, and if the vehicle is traveling at a low speed, then the method moves to block 102.

At block 102, a force that may be applied by the EMA 27 is limited to a preset value (e.g., a value corresponding to a low force). Preferably, the force is limited to a value that is slightly greater (e.g., one to five percent) than the force required to provide motion to the EMA's ram 35. For example, if the total system losses (e.g., mechanical and electrical losses of the EMA) for moving the ram 35 are three percent of the total or rated force of the EMA 27, then preferably the force limit for the EMA 27 is set between four and eight percent of the total rated force of the EMA. In the context of the servo brake system of FIG. 1, for example, the force limit may be applied as a “current limit” on the servo motors 33 (i.e., a maximum current that may be applied to the servo motor 33). Such current limit may be implemented by the servo amplifier 28, for example.

Once the force that may be applied by the EMA 27 is limited, then at block 104 the EMA's ram 35 is commanded to traverse toward the brake disk stack 80. For example, the EMA 27, which in the present example includes the servo motor 33, can be commended by the servo amplifier 28 to follow a particular position reference signal. The position reference signal may identify a particular location along an axis of motion of the ram 35, and if the servo controller detects that the actual ram position (e.g., as detected by the position sensor 36) is not in agreement with the position reference signal, the servo amplifier 28 will provide appropriate power to the motor 33 so as to achieve the desired ram position. To traverse the ram 35 toward the brake disk stack 80, for example, the servo amplifier 28 may be provided with a position reference signal that identifies a position along the x-axis that lies within the brake disk stack 80. To satisfy this position reference, the servo amplifier 28r provides power to the motor so as to drive the ram 35 toward and into the brake disk stack 80.

At block 106, the actual position of the ram 35 is monitored. This can be accomplished, for example, by reading the data provided by the position sensor 36, as is conventional. Preferably, the position sensor 36 is embodied as an LVDT 74 or other device that is insensitive to a power loss. However, it is noted that other means, such as an absolute encoder or the motor resolver could be used to provide data indicative of ram position. That is, the controller can use the output of the resolver to determine the location of the ram 35 along the axis of motion.

If at block 108 it is determined that the ram 35 is moving, then the method loops at block 106. If it is determined that the ram 35 is not moving, then, due to the limited force that may be applied by the EMA (as a result of the limit set at block 102), the EMA 27 cannot significantly compress the brake disk stack 80 and, thus, no noticeable vehicle deceleration will occur. The current “non-moving” location of the ram 35 then is identified as the “just touching” position, and at block 110 this location is recorded as the “just touching” position.

At block 112, a determination is made whether or not the “just touching” measurement will be repeated. If not, then the ram 35 is maintained at the last “just touching” position and the method ends. However, if the measurement will be repeated, then a determination is made with regard to the frequency of the measurement.

The frequency of the “just touching” measurement may be based on the energy dissipated by the brakes, for example, wherein if the dissipated energy is relatively high, then the measurement frequency is increased (e.g., to take into account high thermal expansion and contraction rates), and if the dissipated energy is low, the measurement frequency may be decreased (e.g., due to low thermal expansion and contraction rates). Determination of high or low energy dissipation may be correlated to whether or not high speed braking has recently taken place. For example, if high speed braking has recently occurred, then it may be concluded that the energy dissipated by the brakes is high, and if high speed braking has not recently occurred, then it may be concluded that the energy dissipated by the brakes is low. It is noted that the term “recent” in this paragraph is a relative term, and is dependent on the type of vehicle and/or brakes. For example, on an aircraft high speed braking within the last thirty minutes may be considered recent, while for smaller vehicles the period may be shorter (e.g., five minutes).

At block 114, it is determined if high speed braking has recently occurred. If it has not recently occurred, then at block 116 the frequency is set to a low frequency (e.g., once per minute). If high speed braking has recently occurred, then at block 118 the frequency is set to a high frequency (e.g., six times per minute). Again, the referenced frequencies are merely exemplary, and other frequencies are possible.

Next at block 120, a determination is made if the period for performing the measurement has expired (i.e., the period as set in blocks 116 or 118). If the period has not expired, then the method loops a block 120. Once the period has expired, then the method moves back to block 100 and repeats at the desired frequency.

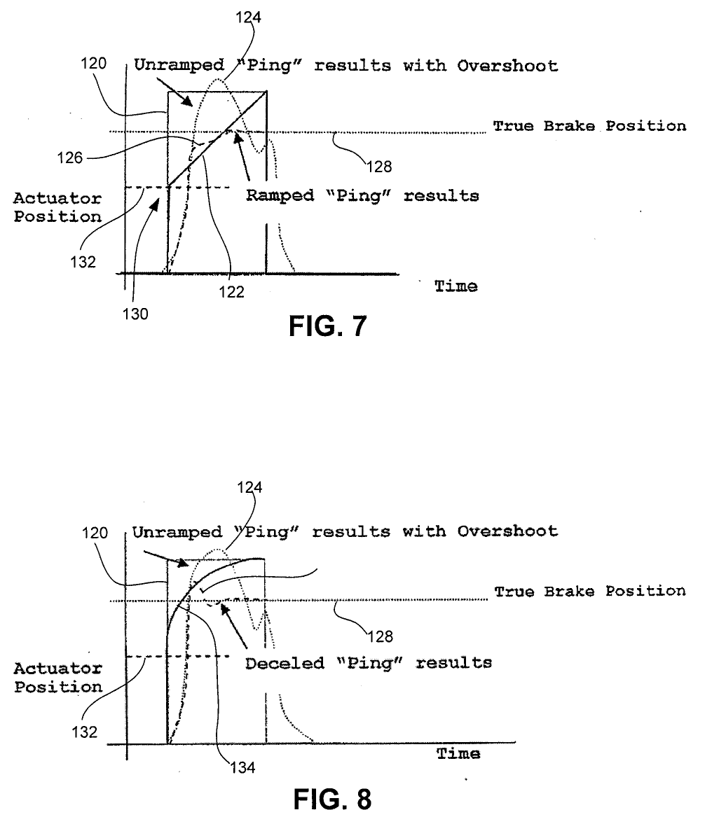

In determining the “just touching” position, the ram 35 may be moving at a high rate of speed toward the brake disk stack 80. As a result of the high speed, significant inertial energy may be stored in the EMA (e.g., in the motor, gear and ram). This inertial may cause the ram 35 to push far into the stack 80 (even with the very low force limit as set at block 102). To address this issue, the commanded ram position reference (e.g., the commanded reference as set at block 104) can be ramped using an offset ramp function, as discussed below with regard to FIG. 7.

FIG. 7 illustrates the commanded position reference implemented via a conventional step function 120 and via an offset ramp function 122 (e.g., a linear ramp wherein a ramp enable location is offset on the x-axis). Also shown in FIG. 7 is the actual ram position 124 obtained using the step function 120, and the actual ram position 126 using the offset ramp function 122. As can be seen, when the commanded position is implemented as a step function 120, the actual ram position 124 significantly overshoots the true brake position 128 (i.e., the ram 35 pushes into the stack). This may lead to false detection of the “just touching” position of the ram 35 and/or delays in determining the location. When using the offset ramp function 122, however, the actual ram position 126 quickly settles into the true brake position 128, with little or no overshoot.

The offset ramp function 122 includes a start position 130 (i.e., the position where the ramp slope changes) calculated, for example, from the last determined “just touching” position 132 (inches) minus the product of the maximum rate of displacement change of the ram 35 (inches per second) and the time (seconds) since the “just touching” position was last determined. This example takes the last stack reading and backs the ramp down an amount proportional to the time since the last ping, which allows for uncertainty. Preferably, the ramp rate is set such that it provides acceptable overshoot levels, corresponding force levels, and quick test results.

Alternatively, a ramp function can be implemented that includes a ramp rate that is variable (e.g., a parabolic ramp function) based on the actual position of the ram 35 (e.g., the ramp rate can correspond to the probability of the ram position arriving at the “just touching” position). For example, a high ramp rate (e.g., almost a step function) can be initially applied to the commanded position. As the ram 35 approaches the brake disk stack 80, the ramp rate is continually decreased so as to taper or curve the commanded position as the ram approaches the brake disk stack 80 (e.g., the ramp rate is continually decreased as the probability of the ram 35 touching the brake disk stack increases). As the ramp rate is decreased, the velocity of the ram 35 also decreases, thereby allowing the ram to settle onto the just touching position. FIG. 8 illustrates this ramp function, wherein the commanded position 134 is quickly ramped to an intermediate value, and then eased into the desired target position. This results in the actual ram position 136 slightly overshooting the true brake position 128, and then quickly settling in. An advantage of this ramping method is that it results in a shorted time to determine the “just touching” point.

Thus, by including a ramping function, the shape of the commanded signal can be modified so as to minimize brake application and/or improve accuracy of the determined “just touching” position. The time in which the stack position was last resolved can be taken into account to compensate for thermal effects (the longer the time period between determinations the more likely thermal effects have changed the stack location).

Once the “just touching” position has been determined, it may be provided to the servo amplifiers 28 corresponding to one or more other EMAs of the brake. Alternatively, each EMA 27 may perform the just touching measurement independent of other EMAs. The results of the respective measurements can be compared to determine in a discrepancy exists. If so, a warning may be issued to alert the appropriate personnel of the problem.

An advantage of operating the EMAs independent of one another is that side effects from other EMAs applying a force to the stack can be eliminated. This can be accomplished, for example, by sequencing the process such that when each EMA is resolving the stack, no other EMAs are resolving the stack.

Accordingly, a brake controller, system and method is provided for determining a “just touching” position of the ram and brake disk stack. Once the location has been determined, the respective rams can be maintained in this position, thereby optimizing braking response.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

In addition, the invention is considered to reside in all workable combinations of features herein disclosed, whether initially claimed in combination or not and whether or not disclosed in the same embodiment.

What is claimed is:

1. A brake system comprising:
a brake disk stack;
a reciprocating ram;
a motive device operatively connected to the reciprocating ram for selectively moving the reciprocating ram into and out of forceful engagement with the brake disk stack for applying and releasing braking force on a rotatable wheel;
a controller for controlling the motive device for selective control of the reciprocating ram and regulation of the force applied by the reciprocating ram against the brake disk stack; and
a position sensor which supplies a position signal representative of the position of the reciprocating ram,
wherein the controller is configured to effect displacement of the reciprocating ram and to determine a position at which the reciprocating ram makes initial contact with the brake disk stack.

2. The brake system according to claim 1, wherein said controller is configured to
limit a force that can be applied by the motive device to the reciprocating ram and to the brake disk stack;
command the reciprocating ram to traverse into the brake disk stack; and
when the reciprocating ram contacts the brake disk stack and stops moving, identify the stopped position of the reciprocating ram as the stack closure position.

3. The brake system according to claim 1 wherein the controller is configured to use the determined stack closure position as a reference position for at least one other reciprocating ram of the brake system.

4. The brake system according to claim 1 wherein the controller is configured to repeatedly resolve the stack closure at a predetermined frequency.

5. The brake system according to claim 4, wherein the controller is configured to increase the frequency after a high speed braking event.

6. The brake system according to claim 1 wherein the controller is configured to use an offset ramp to generate a position reference signal for the reciprocating ram.

7. The brake system according to claim 6, wherein the controller is configured to set a ramp enable location of the offset ramp based on a last determined stack closure position minus the product of the elapsed time since last determining the stack closure position and a maximum rate of displacement change of the ram.

8. The brake control system according to claim 1 wherein the controller is configured to implement a parabolic ramp function to generate a position reference signal for the reciprocating ram.

9. The brake system according to claim 8, wherein the controller is configured to ramp the position reference signal of the reciprocating ram at a rate that corresponds to the probability of the reciprocating ram being at the stack closure position.

10. The brake system according to claim 9, wherein the controller is configured to ramp the position reference signal at an initial ramp rate, and then decrease the ramp rate as the probability of the reciprocating ram making initial contact with the brake disk stack increases.

11. The method according to claim 1 wherein the controller is further configured to maintain the reciprocating ram at the stack closure position during non-braking periods.

12. The brake system according to claim 1 wherein the position sensor includes a LVDT transducer.

13. The brake system according to claim 1 wherein said controller includes a processor for controlling the position of the actuator ram and the force applied by the ram against the brake disk stack.

14. A method for resolving stack closure of a brake disk stack in a brake system, the brake system including a motive device operatively connected to a reciprocating ram for selectively moving the reciprocating ram into and out of forceful engagement with the brake disk stack for applying and releasing braking force on a rotatable member, and a controller for controlling the motive device for selective control of the reciprocating ram and regulation of the force applied by the reciprocating ram against the brake disk stack, said method comprising the steps of:
limiting a force that can be applied by the reciprocating ram to the brake disk stack;
commanding the reciprocating ram to traverse into the brake disk stack; and
when the reciprocating ram contacts the brake disk stack and stops moving, identifying the stopped position of the reciprocating ram as the stack closure position.

15. The method according to claim 14, further comprising using the determined stack closure position as a reference position for at least one other reciprocating ram of the brake system.

16. The method according to claim 14 further comprising repeatedly resolving the stack closure at a predetermined frequency.

17. The method according to claim 16, further comprising increasing the frequency after a high speed braking event.

18. The method according to claim 14 wherein commanding the reciprocating ram to traverse into the brake disk stack includes using an offset ramp to generate a position reference signal for the reciprocating ram.

19. The method according to claim 18, wherein using the offset ramp comprises setting a ramp enable location based on a last determined stack closure position minus the product of the elapsed time since last determining the stack closure position and a maximum rate of displacement change of the reciprocating ram.

20. A brake controller for resolving stack closure of a brake disk stack in a brake system, the brake system including a motive device operatively connected to a reciprocating ram for selectively moving the reciprocating ram into and out of forceful engagement with the brake disk stack for applying and releasing braking force on a rotatable member, said brake controller operative to control the motive device for selective control of the reciprocating ram and regulation of the force applied by the reciprocating ram against the brake disk stack, said brake controller comprising:
a processor and memory; and
logic stored in memory and executable by the processor, said logic including
logic that limits a force that can be applied by the motive device to the reciprocating ram and to the brake disk stack;
logic that commands the reciprocating ram to traverse into the brake disk stack; and
logic that when the reciprocating ram contacts the brake disk stack and stops moving, identifies the stopped position of the reciprocating ram as the stack closure position.
